(19) United States
(12) Patent Application Publication
(10) Pub. No.: US 2003/0109249 A1
(43) Pub. Date: Jun. 12, 2003

(54) System, method and apparatus to deliver guaranteed advertising

(76) Inventor: William Frantz, San Diego, CA (US)

Correspondence Address: Hughes Electronics Corporation, Patent Docket Administration, P.O. Box 956, Bldg. 1, Mail Stop A109, El Segundo, CA, 90245-0956, US

(21) Appl. No.: 10/010,486

(22) Filed: Dec. 7, 2001

(51) Int. Cl. H04M 3/42

(52) U.S. Cl. 455/414; 455/412

(57) ABSTRACT

A communication method, system and apparatus which transmits, receives, and stores multimedia messages that may include advertising data, as well as instructions for displaying the advertising on a targeted subscriber's display device, in place of a currently viewed live broadcast. The system and apparatus provides advertisement content to the desired viewers, by detecting the presence of the viewer operating the communication apparatus (i,e., turning it on to view broadcast programming), so as to display the multimedia messages only when the viewer is present, thereby ensuring content providers that their advertisements will be viewed by a particular demographic group at a particular, optimal or desired time.

### BACKGROUND OF THE INVENTION

1. Field of the Invention.

The present invention relates to communication systems in general, and more particularly to a method, system and apparatus that can deliver guaranteed advertising to targeted subscribers in a global viewing audience.

2. Description of Related Art

Conventional satellite communication systems typically mix advertisement content together with the broadcast entertainment content in packetized streams, called data packets, and then deliver the data packets to receivers of subscribers in a global viewing audience. Each packet typically has a “transport block” which includes the data that is the actual usable information (i.e., the entertainment and advertising content) sent from a program provider. The transport block includes segments of the entertainment programming and segments of commercial advertising.

Accordingly, one of the disadvantages of this system is that there is little flexibility in the delivery of targeted advertising, particularly regarding the ability to target specific advertising to a particularly desired or targeted demographic group or audience. For example, the commercials may or may not be received by all members of the targeted audience. Additionally, demographic targeting is limited to knowledge of the demographics of the entire broadcast entertainment viewing audience as a whole (i.e., an entire geographical region such a the Northeast or Midwest United States).

Further, some viewers not specifically targeted end up watching the same advertisement multiple times, over and over within a short time period ranging from a few days to even a few hours. This becomes annoying and counterproductive to the advertiser, as many viewers end up watching advertisements that are not even pertinent or interesting personally to them or to their needs as a demographic group. Accordingly, what is needed is a system that more effectively delivers desired advertising to specific or targeted viewers in a global subscriber audience.

### SUMMARY OF THE INVENTION

The present invention provides a communication method, system and apparatus which is capable of receiving and storing multimedia messages. These multimedia messages may include advertising data, as well as instructions for displaying the advertising on a targeted subscriber's display device, in place of the currently viewed live broadcast. Additionally, the communication apparatus is configured to detect the presence of a viewer at the viewer's device, so as to trigger playing the stored messages in place of the live broadcast.

Specifically, data packets containing the multimedia messages are transmitted separately from the data packets content the live broadcast content. These packets can be sent before the live broadcast, for example, to be stored and played at some optimal time during the later-arriving live broadcast. Accordingly, the communication system and apparatus of the present invention offers improved flexibility in the delivery of targeted advertising, particularly regarding the ability to target specific advertising to a particularly desired or targeted demographic group or audience.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings, wherein like elements are represented by like reference numerals, which are given by way of illustration only and thus are not limitative of the present invention and wherein:

FIG. 1 is an exemplary arrangement of the communication system in accordance with the invention;

FIG. 2 illustrates a general data flow in a direct broadcast satellite or digital video broadcast system in accordance with the invention;

FIG. 3 illustrates architecture of an exemplary communication apparatus used with the communication system of the present invention;

FIG. 4 illustrates a method of transmitting and receiving the multimedia messages in accordance with the invention; and

FIG. 5 illustrates a method for displaying a stored multimedia message in accordance with the invention; and

FIG. 6 illustrates an exemplary data flow path to display the multimedia message in accordance with the invention.

### DETAILED DESCRIPTION

The communication method, system and apparatus of the present invention transmits, receives, and stores multimedia messages that may include advertising data, as well as instructions for displaying the advertising on a targeted subscriber's display device, in place of the currently viewed live broadcast. Additionally, the communication apparatus is configured to detect the presence of a viewer, so as to trigger playing the stored messages in place of a live broadcast.

By using demographic data, advertisers may utilize the communication system to provide advertising content that would more effectively target specific demographic groups of consumers/subscribers. Moreover, the system of the present invention ensures that advertisement content reaches the desired viewers, by detecting the presence of the viewer operating the communication apparatus (i.e., turning it on to view broadcast programming, so as to playing the multimedia messages only when the viewer is present, thereby ensuring advertisers that their content will be viewed by a particular demographic group at a particular, optimal or desired time.

Accordingly, the communication apparatus of the present application enables advertising content to be delivered separately from the broadcast entertainment content. In an aspect, stored multimedia snippets such as advertising or commercial snippets are displayed in place of the currently-viewed live broadcast on the subscriber's display device. Preferably, these messages are displayed at natural points where the broadcast entertainment content is breaking for a commercial. The multimedia messages are stored in a mass storage device operatively connected and/or subsumed within the communication apparatus. These messages are accessed by a central processor of the communication apparatus from storage, decoded and encoded (converted) to suitable A/V signals for display on a display device operatively connected to the communication apparatus.

The communication apparatus of the present invention also has local intelligence, such as a sensor, in order to determine when the user is watching the display device that is connected thereto. Moreover, the central processor sends out control streams instructing the communication apparatus when to show the stored multimedia messages.

Hence, the central processor controls the mass storage device, decoding and encoding circuitry, etc., in order to retrieve the stored data representing the multimedia messages at the appropriate time, encode and decode the data into a suitable form for display on a TV, and send it to a suitable display device for display. Preferably, command/control data within each received multimedia message and/or within the broadcast entertainment content, may provide instructions to the central processor as to when the message should be displayed in lieu of the live broadcast content.

The flexibility inherent in the present invention provides a vehicle whereby all messages such as advertisements and commercials are practically guaranteed to be delivered to the desired and proper viewers or subscribers in the viewing audience. Additionally, and unlike conventional broadcast programming, not all viewers or subscribers in one geographical area will be forced or required to watch the same commercials as in a different geographical area. Further, the broadcaster or commercial source of broadcasting content has almost complete control over how often a viewer or subscriber is to see a particular advertisement, as well as which advertisements they will receive.

Moreover, the broadcaster can leverage potential advertisers for sales, in that with the system and method of the invention the advertiser will know which people are receiving a particular advertisement, would have complete control over the people seeing the advertisement, and that the broadcaster could almost guarantee that the advertiser's prospective commercials/ads would be seen by subscribers in the viewing audience a particular amount of time over a particular period. Further, the system provides the ability to utilize demographic profiling in order to ensure that advertisers reach their desired or targeted audience. Demographic information can be collected and used to a much finer level of detail than what is currently available utilizing the coarse demographics of a particular entertainment program that is broadcasted to a wide-ranging viewing audience.

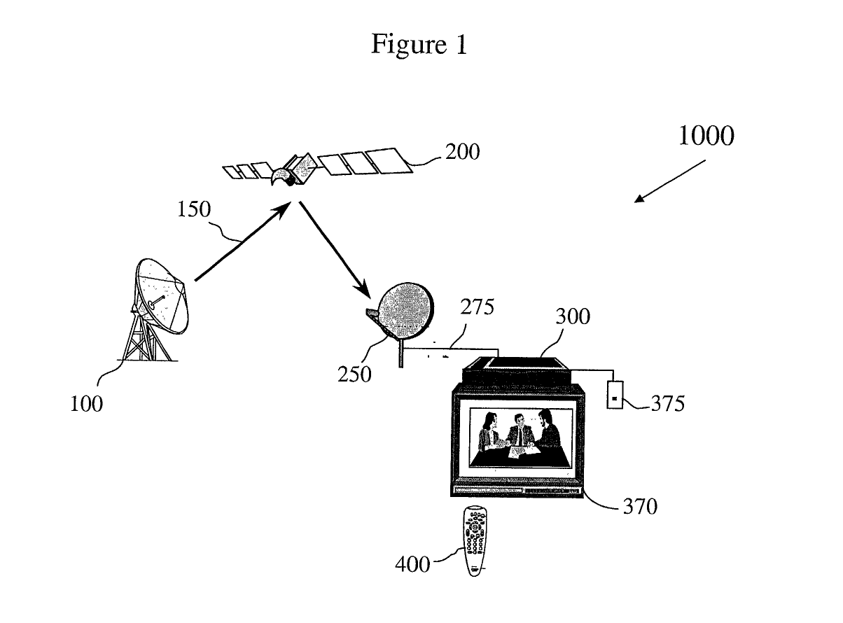

FIG. 1 is an exemplary arrangement of a communication apparatus within an exemplary communication system in accordance with the invention. The communication system 1000 may be a direct broadcast satellite or digital video broadcast (DVB) system. In the exemplary embodiment of FIG. 1, the system 1000 may comprise a transmit antenna station (hereinafter referred to as uplink facility 100 for clarity), satellite 200, receive antenna 250 and communication apparatus 300.

The transmit antenna station may be a DIRECTV® satellite uplink facility, for example, or any other earth station as described above and which is well known in the art. The bitstream or airlink 150 is a suitable content signal such as a digital audio and video television data signal (A/V signal), the medium is a satellite 200, and the receive antenna 250 is preferably an outdoor unit (ODU). As illustrated in FIG. 1, the ODU is connected to communication apparatus 300 via coaxial cable 275.

In this exemplary embodiment, the communication apparatus 300 may be any device able to communicate with satellite, digital video and/or CATV broadcast system. For example, the communication apparatus 300 may be a receiver is a receiver, and may preferably also be a set-top box (STB) having receiver circuitry. Hereinafter, the communication apparatus 300 is referred to as STB 300.

The invention is applicable to any communication apparatus, receiver or STB having a multiple-processor configuration. STB 300 may further be connected to a display 370, such as a standard definition television, a high definition television or a PC monitor and also may be connected to a telephone line 375. The STB 300 may be controlled via a remote control 400 as is well known in art, using known RF and/or IR transmission and reception techniques.

The user command interface in the present invention however is not limited to a remote control device. Alternatively, any of function buttons residing on the STB structure itself, a graphical user interface (GUI) such as a browser, a keyboard operatively connected thereto and/or connected to a PC that is in communication with the STB, USB serial ports, voice-activation software devices within or operatively connected to the STB, or command and/or instructions by remote call-in using DTMF tones for example, may be substituted as a user command interface to the STB 300.

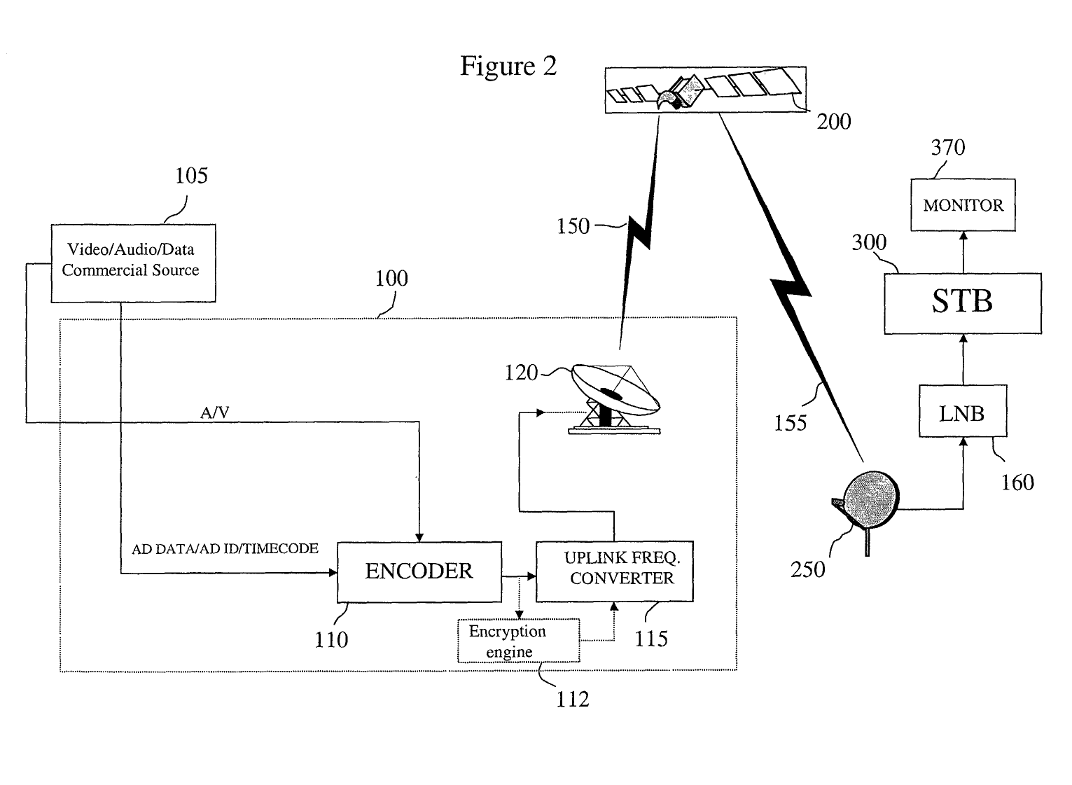

FIG. 2 illustrates the general data flow in a direct broadcast satellite or digital video broadcast system in accordance with the invention. In operation, the uplink facility 100 can receive video and audio programming from a number of sources, including satellites, terrestrial fiber optics, cable, or tape. Preferably, the received programming signals, along with data signals such as electronic scheduling data and conditional access data, are sent from some commercial source 105 to a video/audio/data encoding system 110 within uplink facility 100. Here, they are digitally encoded and multiplexed into a packetized data stream using a number of conventional algorithms, including convolution error correction and compression, for example.

In a conventional manner, the encoded data stream is modulated and sent through an uplink frequency converter 115 which converts the modulated encoded data stream to a frequency band suitable for reception by the satellite 200. Preferably, the satellite frequency is K-band such as in the Ku-band; however the frequency may be in the Ka band as well. The modulated, encoded data stream is then routed from the uplink frequency converter 115 to an uplink satellite antenna/dish 120, where it is broadcast toward the satellite 200 over the airlink 150. The encoded data stream may be encrypted and encoded, by a suitable encryption engine 112 (dotted lines), or not encrypted and encoded.

The satellite 200 receives the modulated, encoded Ku-band data stream via airlink 150, and re-broadcasts it downward via downlink 155 toward an area on earth that includes the various receiver stations (STB 300, for example). In this embodiment, the satellite dish (ODU 250) of STB 300 shifts the Ku-band signal down to an L-band signal which is transmitted via a LNB downconverter 160 to STB 300, for eventual reproduction on display monitor 370.

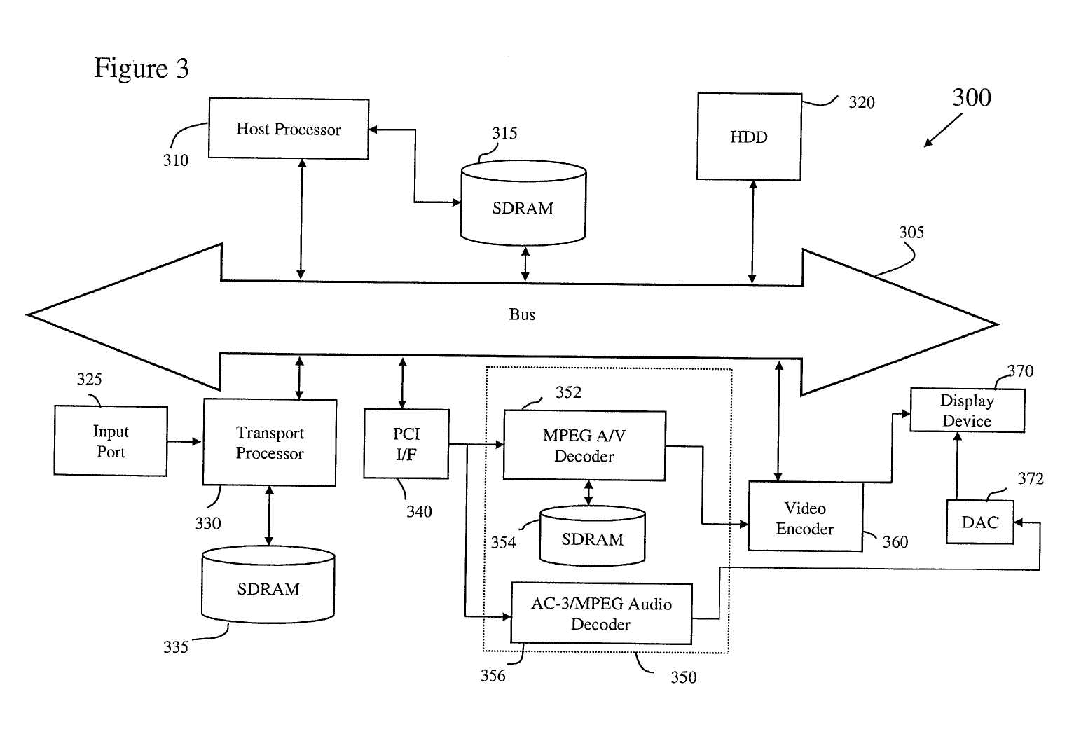

Front-end circuitry, which may or may not be part of STB 300, receives the L-band RF signals from the LNB downconverter 160 and converts them back into the original digital data stream. The front-end circuitry may include a tuner. Circuitry (shown and explained in more detail in FIG. 3) receives the original data streams via an input port and performs video/audio processing operations such as de-multiplexing and decompression. The overall operation of STB 300, including the selection of parameters, the set-up and control of components, channel selection, a user's access to different program packages, and many other functions, both real time and non-real time, are controlled by one or more processors within STB 300, as will be further explained below.

FIG. 3 illustrates an exemplary architecture of a communication apparatus such as in accordance with the invention. The STB 300 utilizes a bus 305 to interconnect various components and to provide a pathway for data and control signals.

FIG. 3 illustrates a host processor 310, a memory device 315 (in an exemplary configuration embodied as an SDRAM 315) and a hard disc drive (HDD) 320 connected to the bus 305. In this embodiment, the host processor 310 may also have a direct connection to SDRAM 315 as shown in FIG. 3 (i.e., such that SDRAM 315 is associated as the memory for host processor 310). Although memory device 315 is described as SDRAM 315 hereinafter in the present application, memory devices of EDO RAM (extended data output DRAM), BEDO RAM (Burst EDO RAM), RLDRAM by Rambus, Inc., SLDRAM by the SyncLink Consortium, VRAM (video RAM), or any other known or developing memory that is writeable may be sufficient as memory device 315.

As further shown in FIG. 3, a transport processor 330 and PCI I/F 340 (peripheral component interconnect interface) are connected to the bus 305. The transport processor 330 also has a connection to input port 325 and SDRAM 335. SDRAM 335 has the same attributes as SDRAM 315 and may be replaced with any of the other above-noted alternative memory devices. Furthermore, the PCI I/F 340 is connected to a decoder 350. The decoder 350 is connected to a video encoder 360. The output of video encoder 360 is in turn sent to a display device 370. Decoder 350 may include both an MPEG A/V decoder 352 and an AC3/MPEG audio decoder 356, the output of the latter being sent to display device 370 after conversion in a digital-to-analog converter (DAC) 372.

The host processor 310 may be constructed with conventional microprocessors such as the currently available PENTIUM processors from Intel. Host processor 310 performs non real-time functions in the STB 300, such as graphical-user interface and browser functions. A browser is a software engine that presents the interface to, and interacts with, a user of the STB 300. The browser is responsible for formatting and displaying user-interface components and pictures. Typically, the user interface is displayed as a Graphical User Interface (GUI).

Browsers are often controlled and commanded by the standard HTML language, which is used to position and format the GUI. Additionally, or in the alternative, any decisions and control flow of the GUI that requires more detailed user interaction may be implemented using JavaScript™. Both of these languages may be customized or adapted for the specific details of a given STB 300 implementation, and images may be displayed in the browser using well known JPG, GIF and other standardized compression schemes. It is noted that other non-standardized languages and compression schemes may be used for the browser and GUI, such as XML, “home-brew” languages or other known non-standardized languages and schemes.

HDD 320 is actually a specific example of a mass storage device. In other words, the HDD 320 may be replaced with other mass storage devices as is generally known in the art, such as known magnetic and/or optical storage devices, (i.e., embodied as RAM, a recordable CD, a flash card, memory stick, etc.). In an exemplary configuration, HDD 320 may have a capacity of at least about 25 Gbytes, where preferably about at least 20 Gbytes is available for various recording applications, and the remainder flexibly allocated for pause applications in STB 300.

The bus 305 may be implemented with conventional bus architectures such as a peripheral component interconnect (PCI) bus that is standard in many computer architectures. Alternative bus architectures such as VMEBUS from Motorola, NUBUS, address data bus, RAM bus, DDR (double data rate) bus, etc., could of course be utilized to implement bus 305.

The transport processor 330 performs real-time functions and operations such as control of the A/V data flow, conditional access, program guide control, etc., and may be constructed with an ASIC (application specific integrated circuit) that contains, for example, a general purpose R3000A MIPS RISC core, with sufficient on-chip instruction cache and data cache memory. Furthermore, the transport processor 330 may integrate system peripherals such as interrupt, timer, and memory controllers on-chip, including ROM, SDRAM, DMA controllers; a packet processor, crypto-logic, PCI compliant PC port, and parallel inputs and outputs.

The implementation shown in FIG. 3 actually shows the SDRAM 335 as being separate from the transport processor 330, it being understood that the SDRAM 335 may be dispensed with altogether or consolidated with SDRAM 315. In other words, the SDRAMs 315 and 335 need not be separate devices and can be consolidated into a single SDRAM or other memory device.

The input port 325 receives audiovisual bitstreams that may include, for example, MPEG-1 and MPEG-2 video bitstreams, MPEG-1 layer II audio bitstreams and DOLBY DIGITAL (AC-3) audio bitstreams. Exemplary A/V bitrates may range from about 60 Kbps to 15 Mbps for MPEG video, from about 56-384 Kbps for MPEG audio, and between about 32-640 Kbps for AC-3 audio. The single-stream maximum bitrate for STB 300 may correspond to the maximum bitrate of the input programming, for example 16 Mbps or 2 MBps, which corresponds to the maximum MPEG-2 video bitrate of 15 Mbps, maximum MPEG-1 Layer-2 audio bitrate of 384 kbps, and maximum AC-3 bitrate of 640 kbps.

Any audio or video formats known to one of ordinary skill in the art could be utilized. Although FIG. 3 has been described in conjunction with digital television, the signal supplied could be any type of television signal, any type of audio or video data, or any downloadable digital information. Of course, various other audiovisual bitstream formats and encoding techniques may be utilized in recording. For example, STB 300 may record an AC-3 bitstream, if AC-3 broadcast is present, along with MPEG-1 digital audio. Still further, the received audiovisual data may be encrypted and encoded or not encrypted and encoded. If the audiovisual data input via the input port 325 to the transport processor 330 is encrypted, then the transport processor 330 may perform decryption. Moreover, the decryption may be performed instead by the host processor 310.

Alternatively, the host processor 310 and transport processor 330 may be integrated or otherwise replaced with a single processor. As mentioned above, the SDRAMs (315 and 335) may be consolidated or replaced with a single SDRAM or single memory device.

The PCI I/F 340 may be constructed with an ASIC that controls data reads from memory. Audiovisual (A/V) data may be sent to the host processor 310's memory (SDRAM 315) while simultaneously being sent to an MPEG A/V decoder 352, as further discussed below.

Decoder 350 may be constructed as shown in FIG. 3 by including the MPEG A/V decoder 352 connected to the PCI I/F 340, as well as an AC-3/MPEG audio decoder 356 which is also connected to the PCI I/F 340. In this way, the video and audio bitstreams from the PCI I/F 340 can be separately decoded by decoders 352 and 356, respectively. Alternatively, a consolidated decoder may be utilized that decodes both video and audio bitstreams together. The encoding techniques are not limited to MPEG and AC-3, of course, and can include any known or future developed encoding technique. In a corresponding manner, the decoder 350 could be constructed to process the selected encoding technique(s) utilized by the particular implementation desired.

In order to more efficiently decode the MPEG bitstream, the MPEG A/V decoder 352 may also include a memory device such as SDRAM 354 connected thereto. This SDRAM 354 may be eliminated, consolidated with decoder 352 or consolidated with the other SDRAMs 315 and/or 335. SDRAM 354 has the same attributes as SDRAM 315 and 335, and may be replaced with any of the other above-noted alternative memory devices.

Video encoder 360 is preferably an NTSC encoder that encodes, or converts the digital video output from decoder 350 into a coded analog signal for display. Regarding the specifications of the NTSC (National Television Standards Committee) encoder 360, the NTSC is responsible for setting television and video standards in the United States. The NTSC standard for television defines a composite video signal with a refresh rate of 60 half-frames (interlaced) per second. Each frame contains 525 lines and can contain 16 million different colors.

In Europe and the rest of the world, the dominant television standards are PAL (Phase Alternating Line) and SECAM (Sequential Color with Memory). Whereas NTSC delivers 525 lines of resolution at 60 half-frames per second, PAL delivers 625 lines at 50 half-frames per second. Many video adapters or encoders that enable computer monitors to be used as television screens support both NTSC and PAL signals. SECAM uses the same bandwidth as PAL but transmits the color information sequentially. SECAM runs on 625 lines/frame.

Thus, although use of a video encoder 360 is envisioned to encode the processed video for display on display device 370, the present invention is not limited to the NTSC standard encoder. PAL and SECAM encoders may also be utilized. Further, hi-definition television (HDTV) encoders may also be viable to encode the processed video for display on a HDTV, for example.

Display device 370 may be an analog or digital output device capable of handling a digital, decoded output from the video encoder 360. If analog output device(s) are desired, to listen to the output of the AC3/MPEG audio decoder 356, a digital-to-analog converter (DAC) 372 is connected to the decoder 350. The output from DAC 372 is an analog sound output to display device 370, which may be a conventional television, computer monitor screen, portable display device or other display devices which are known and used in the art. If the output of the AC-3/MPEG audio decoder 356 is to be decoded by an external audio component, a digital audio output interface (not shown) may be included between the AC-3/MPEG audio decoder 356 and display device 370. The interface may be a standard interface known in the art such as a SPDIF audio output interface, for example, and may be used with, or in place of DAC 372, depending on whether the output devices are analog and/or digital display devices.

The video output from video encoder 360 and/or audio output from audio decoder 356 or DAC 372 does not necessarily have to be sent to display device 370. Alternatively, encoded A/V data may be output to external devices or systems operatively connected to the STB 300, such an off-broadcast system, cable TV system or other known systems which can reproduce the encoded audio and/or video signals for reproduction and/or display. This may also include a PC that can play video or audio files containing the encoded A/V data sent from the STB 300, for example.

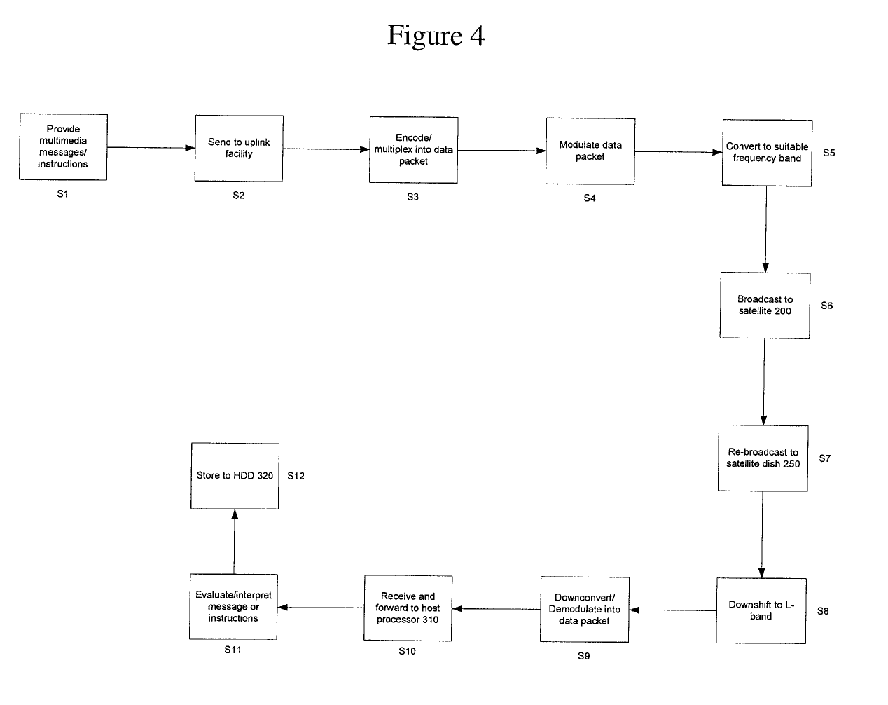

FIG. 4 illustrates a method of transmitting and receiving the multimedia messages in accordance with the invention. FIG. 4 should be review along with FIG. 2. Initially, a content provider such as a commercial source 105 will configure the audio and video data (A/V) representing the multimedia messages (Step S1). This may include providing the advertising content, any header identifier data, encryption data, etc., and instructions for when to play the multimedia messages contained therein. Alternatively, identifier, encryption and coding data can be done at an uplink facility 100, to be discussed below.

Additionally in this step, the commercial source 105 in its instructions will provide instructions as to which subscribers/subscriber area are to receive the multimedia messages

Next, the A/V data is sent to uplink facility 100 (Step S2) and preferably to video/audio/data encoding system 110 within uplink facility 100. Here, they are digitally encoded and multiplexed into a packetized data stream (Step S3) using a number of conventional algorithms, including convolution error correction and compression, for example.

Next, the encoded data stream is modulated (Step S4) and sent through an uplink frequency converter 115 which converts the modulated encoded data stream to a frequency band suitable for reception (Step S5) by the satellite 200. The modulated, encoded data stream is then routed from the uplink frequency converter 115 to an uplink satellite antenna/dish 120, where it is broadcast (Step S6) toward the satellite 200 over the airlink 150.

The satellite 200 receives the modulated, encoded data stream via an airlink, and re-broadcasts it downward (Step S7) via a downlink toward an area on earth that includes the various designated communication devices (i.e., STB 300/receivers). Each STB 300 has a corresponding satellite dish (ODU 250) which downshifts received signal to an L-band signal (Step S8)

Front-end circuitry such as a tuner receives the L-band RF signals from the LNB downconverter 160 and converts them back into the original digital data stream (Step S9). Input port 325 receives the original data stream of multimedia messages, and sends it to host processor 310 (Step S10). Host processor 310 evaluates the received stream, utilizing algorithms and software processes to interpret the instructions therein (Step S11) and then stores the received data stream of multimedia messages in HDD 320 (Step S12).

The instructions interpreted by host processor 310 may include trigger information as to when to display the multimedia messages. For, example, on trigger can be at 30 minutes after the viewer turns on the communication device or entertainment system containing STB 300 to watch programming. Another could be at specified times during the day, during specified current and upcoming live broadcast (e.g., during the Super Bowl), etc. Another could be in response to cues embedded in an upcoming live broadcast. The present invention is not limited to these triggering events.

In order to determine when the viewer is watching live content, STB 300 could be configured with a sensory device that is operatively connected to host processor 310. An exemplary arrangement could be IR receiver or sensor circuitry that detects movement, or even the IR receiver circuitry that receives an IR command stream from a remote control. Detection of a received IR signal could be a trigger to inform the host processor to retrieve certain stored multimedia messages for display. The present invention is not limited to this exemplary configuration, as the host processor could be provided with artificial intelligence software that detects movement, RF detection circuitry and/or imaging recognition hardware and software to provide user presence data to host processor 310.

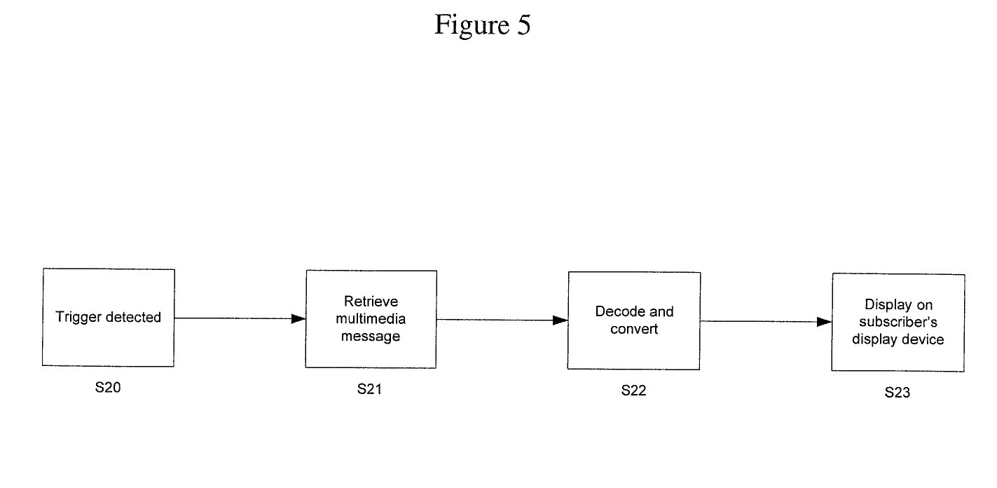

FIG. 5 illustrates a method for displaying a stored multimedia message in accordance with the invention. Referring to FIG. 5, initially a trigger is detected (step S20); in an exemplary scenario this might be detection of a power-on signal. Next, host processor retrieves the stored multimedia message that is to be displayed at that trigger (Step S21). Host processor 310 knows which messages to retrieve based on the instructions interpreted upon receipt from satellite 200.

The multimedia message is sent (as A/V data) for decoding and conversion (Step S22) to a suitable signal for display (Step S23). Accordingly, the multimedia message is displayed in place of the currently viewed live entertainment content, to be viewed by the targeted subscriber. Preferably, the multimedia message is displayed at a break point between the live entertainment content shifting to where the programming would go to a commercial, so as not to irritate the viewer. This may effected be an instruction received by the host processor 310, and/or by the host processor 310 detecting the break in programming.

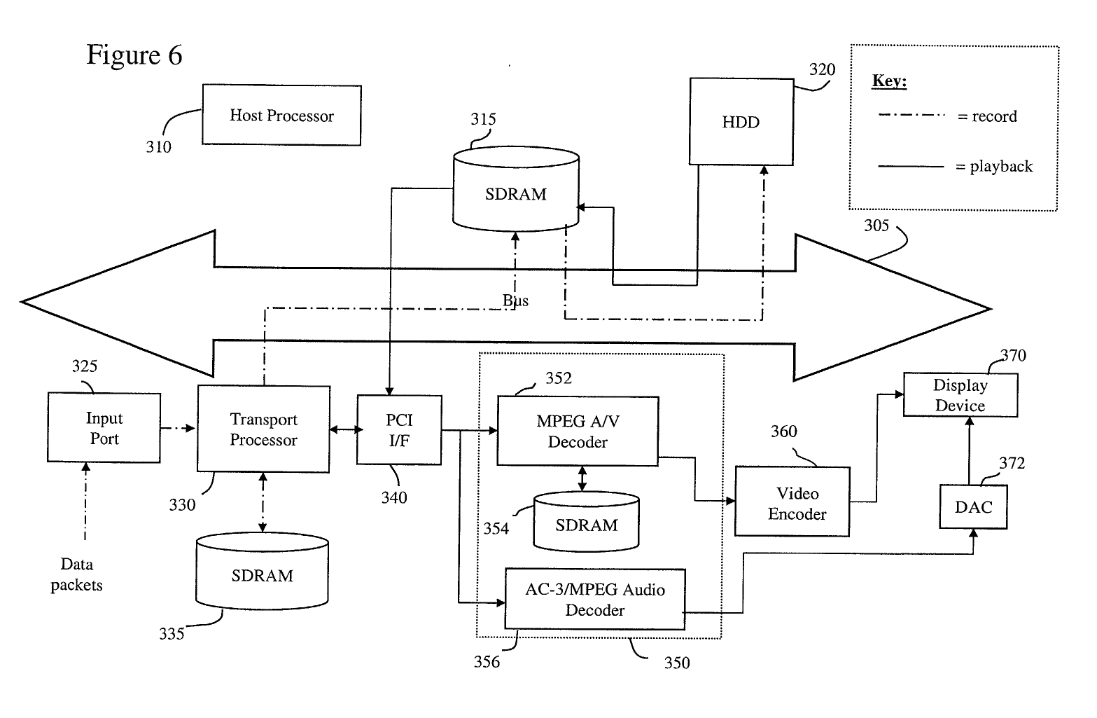

FIG. 6 illustrates an exemplary data flow path to display the multimedia message in accordance with the invention.

FIG. 6 shows the data flows among the various components of the STB 300 for displaying a multimedia message in accordance with the invention. Some of the connections between components, and associated reference numerals from FIG. 3 may have been eliminated in FIG. 6 in order to highlight the data flow which is shown using dashed lines (see Key) in FIG. 6.

When the viewer turns the STB 300 on, a sensor (not shown) sends a message to host processor 310 indicating that the viewer is now watching broadcast content. If the viewing has selected a playback option to display previously recorded programming, the host processor 310 will not retrieve the multimedia messages designated in storage to be displayed over the recorded content. Alternatively, the viewer may be given the option to playback any of the previously recorded programs, events, broadcast, etc., or to watch live programming received from communication system 1000. This may be done, for example, by using a remote control or other suitable user command interface (not shown) to access a menu on display device 370. In any case, when the viewer selects a desired recorded event, the corresponding A/V data (which typically may also include system time and conditional access packets) are retrieved from HDD 320.

Where the viewer is simply watching live broadcast content, host processor 310 automatically searches HDD 320 and/or SDRAM 315 for triggers to determine if there are any multimedia messages to display in the near future (i.e., while the viewer is watching the currently displayed live programming). If so, host processor 310 elects the desired multimedia messages and temporarily caches them in SDRAM 315, or, based on a specific time instruction for display, directly accesses then from HDD 320 for display over the live broadcast content.

Accordingly, the selected A/V data (representing a multimedia message) recorded on HDD 320 is sent via bus 305 to a queue in SDRAM 315. Next, the buffered data is sent from SDRAM 315 via bus 305 to transport processor 330, back to bus 305 and then to PCI I/F 340, which in turn sends the selected A/V data to decoder 350. More specifically, the video portion of the bitstream is sent to MPEG A/V decoder 352, with the audio portion (if applicable) being sent to AC-3/MPEG audio decoder 356.

Within decoder 350, MPEG A/V decoder 352 may be provided with an SDRAM 354 in order to more efficiently decode the MPEG bitstream received from PCI I/F 340. SDRAM 354 is similar to SDRAM 315 discussed above in its construction. SDRAM 354 temporarily holds the encoded video bitstream data, and also provides the three frame buffers required for MPEG decoding, as is known in the art. Thereafter, the decoded A/V data is output to video encoder 360 for conversion to an analog format, so that the multimedia message may be displayed on display device 370.

The invention being thus described, it will be obvious that the same may be varied in many ways. For example, the functional blocks in FIGS. 1-3 and 6 may be implemented in hardware and/or software. The hardware/software implementations may include a combination of processor(s) and article(s) of manufacture. The article(s) of manufacture may further include storage media and executable computer program(s). The executable computer program(s) may include the instructions to perform the described operations. The computer executable program(s) may also be provided as part of externally supplied propagated signal(s). Such variations are not to be regarded as departure from the spirit and scope of the invention, and all such modifications as would be obvious to one skilled in the art are intended to be included within the scope of the following claims.

What is claimed is:

1. A communication system for delivering multimedia messages to subscribers, comprising:
a transmitter for transmitting broadcast programming and multimedia messages to the subscribers as separate data streams; and
at least one communication apparatus having receiver circuitry for receiving said multimedia messages data stream separate from receiving the data stream containing said broadcast programming, each subscriber having at least one communication apparatus, said at least one communication apparatus further including:
a processor operatively connected to a mass storage device for processing and storing said received multimedia messages, wherein
said processor accesses said store multimedia messages for display in place of the broadcast programming being currently-viewed by the subscribers.

2. The communication system of claim 1, wherein said processor displays said stored multimedia messages based upon detecting a trigger.

3. The communication system of claim 2, wherein said trigger is selected from the group comprising at least a detection of a subscriber watching broadcast content, a command from a user interface to view broadcast content, and from instructions received together with the multimedia messages and/or from instructions embedded in the broadcast content.

4. The communication system of claim 1, wherein said transmitter further includes:
an uplink facility for digitally encoding and multiplexing said multimedia messages into a packetized data stream, and for encoding and modulating said data packet into a suitable frequency band for reception; and
a satellite for receiving said data packet via an airlink from the uplink facility, and for transmitting the data packet to said at least one communication apparatus.

5. The communication system of claim 1, wherein said multimedia messages are advertisements or commercials provided by content providers and intended for targeted subscribers.

6. The communication system of claim 5, wherein content providers are assured that an advertisement or commercial reaches the desired subscribers as the content provider knows the targeted subscriber, when the advertisement or commercial will be displayed on a display device operatively connected to the subscriber's communication apparatus, and the amount or length of time the advertisement or commercial is to be displayed for the subscriber.

7. The communication system of claim 1, wherein the communication apparatus is a receiver or a set top box.

8. A method for providing multimedia messages to subscribers in a communication system, comprising:
transmitting broadcast programming and multimedia messages to the subscribers as separate data streams from one location; and
receiving said multimedia messages data stream separate from receiving the data stream containing said broadcast programming at the subscribers location, said received multimedia messages further subject to processing for display in place of the broadcast programming being currently-viewed by the subscribers.

9. The method of claim 8, wherein said multimedia messages are displayed based upon detecting a trigger.

10. The method of claim 9, wherein said trigger is selected from the group comprising at least a detection of a subscriber watching broadcast content, a command from a user interface to view broadcast content, and from instructions received together with the multimedia messages and/or from instructions embedded in the broadcast content.

11. The method of claim 1, wherein said step of transmitting further includes
digitally encoding and multiplexing said multimedia messages into a packetized data stream;
encoding and modulating said digitally encoded data packet into a suitable frequency band for reception; and
transmitting the data packet to said subscribers

12. The method of claim 1, wherein said multimedia messages are advertisements or commercials provided by content providers and intended for targeted subscribers.

13. The method of claim 12, wherein content providers are assured that an advertisement or commercial reaches the targeted subscribers, as the content provider knows the targeted subscriber, when the advertisement or commercial will be displayed to the targeted subscriber, and the amount or length of time the advertisement or commercial is to be displayed for the targeted subscriber.

14. A communication apparatus for processing multimedia messages received from a communication system for viewing by a subscriber, comprising:
receiver circuitry for receiving a multimedia message data stream that is transmitted separately from a data stream containing broadcast programming that is received,
a processor operatively connected to said receiver circuitry and a mass storage device for processing and storing said received multimedia messages, wherein said processor accesses said store multimedia messages for display in place of broadcast programming that is being currently-viewed by the subscriber.

15. The communication apparatus of claim 14, wherein said processor displays said stored multimedia messages based upon detecting a trigger.

16. The communication apparatus of claim 15, wherein said trigger is selected from the group comprising at least a detection of a subscriber watching broadcast content, a command from a user interface to view broadcast content, and from instructions received together with the multimedia messages and/or from instructions embedded in the broadcast content.

17. The communication apparatus of claim 14, wherein said transmitter further includes:
an uplink facility for digitally encoding and multiplexing said multimedia messages into a packetized data stream, and for encoding and modulating said data packet into a suitable frequency band for reception; and
a satellite for receiving said data packet via an airlink from the uplink facility, and for transmitting the data packet to said at least one communication apparatus.

18. The communication apparatus of claim 14, wherein said multimedia messages are advertisements or commercials provided by content providers and intended for targeted subscribers.

19. The communication apparatus of claim 18, wherein content providers are assured that an advertisement or commercial reaches the desired subscribers as the content provider knows the targeted subscriber, when the advertisement or commercial will be displayed on a display device operatively connected to the subscriber's communication apparatus, and the amount or length of time the advertisement or commercial is to be displayed for the subscriber.
